(19) United States
(12) Patent Application Publication
(10) Pub. No.: US 2026/0304498 A1
(43) Pub. Date: Oct. 1, 2026

(54) PHYSICAL RANDOM ACCESS CHANNEL RESOURCE INDICATION VIA PAGING AND PHYSICAL DOWNLINK CONTROL CHANNEL SIGNALING

(71) Applicant: QUALCOMM Incorporated, San Diego, CA (US)

(72) Inventors: Ahmed Attia ABOTABL, San Diego, CA (US); Hung Dinh LY, San Diego, CA (US)

(21) Appl. No.: 19/532,146

(22) Filed: Feb. 6, 2026

Related U.S. Application Data
(60) Provisional application No. 63/778,213, filed on Mar. 26, 2025.

(51) Int. Cl. H04W 74/0838; H04W 68/02; H04W 72/231

(52) U.S. Cl. CPC H04W 74/0838; H04W 68/02; H04W 72/231

(57) ABSTRACT

Various aspects of the present disclosure generally relate to wireless communication. In some aspects, a user equipment (UE) may receive, from a network node, a paging message indicating a first availability configuration associated with a plurality of physical random access channel (PRACH) resources. The UE may receive, from the network node, a physical downlink control channel (PDCCH) order indicating a second availability configuration associated with the plurality of PRACH resources. The UE may transmit, to the network node, a message associated with the plurality of PRACH resources, wherein the plurality of PRACH resources is selected for contention-based random access (CBRA) or contention-free random access (CFRA) based on one or more of the first availability configuration or the second availability configuration. Numerous other aspects are described.

### CROSS-REFERENCE TO RELATED APPLICATION

This Patent Application claims priority to U.S. Provisional Patent Application No. 63/778,213, filed on Mar. 26, 2025, entitled “PHYSICAL RANDOM ACCESS CHANNEL RESOURCE INDICATION VIA PAGING AND PHYSICAL DOWNLINK CONTROL CHANNEL SIGNALING,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with physical random access channel resource indication via paging and physical downlink control channel signaling.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

It involves the management and allocation of network resources to facilitate communication between devices.

In a wireless network, dynamic management and adaptation of network resources may be utilized to facilitate efficient communication between devices. For example, a physical random access channel (PRACH) communication procedure, which is utilized to initiate communication between a user equipment and a network node, can be adjusted in both the time domain and frequency domain to optimize resource utilization and reduce power consumption.

### SUMMARY

Some aspects described herein relate to a user equipment (UE). The UE may include a processing system. The processing system may include one or more processors and one or more code-storing memories coupled with the one or more processors. The processing system may be configured to cause the UE to receive, from a network node, a paging message indicating a first availability configuration associated with a plurality of physical random access channel (PRACH) resources. The processing system may be configured to cause the UE to receive, from the network node, a physical downlink control channel (PDCCH) order indicating a second availability configuration associated with the plurality of PRACH resources. The processing system may be configured to cause the UE to transmit, to the network node, a message associated with the plurality of PRACH resources, wherein the plurality of PRACH resources is selected for contention-based random access (CBRA) or contention-free random access (CFRA) based on one or more of the first availability configuration or the second availability configuration.

Some aspects described herein relate to a network node. The network node may include a processing system. The processing system may include one or more processors and one or more code-storing memories coupled with the one or more processors. The processing system may be configured to cause the network node to transmit, to a UE, a paging message indicating a first availability configuration associated with a plurality of PRACH resources. The processing system may be configured to cause the network node to transmit, to the UE, a PDCCH order indicating a second availability configuration associated with the plurality of PRACH resources. The processing system may be configured to cause the network node to receive, from the UE, a message associated with the plurality of PRACH resources, wherein the message is associated with CBRA or CFRA.

Some aspects described herein relate to a method of wireless communication performed by a UE. The method may include receiving, from a network node, a paging message indicating a first availability configuration associated with a plurality of PRACH resources. The method may include receiving, from the network node, a PDCCH order indicating a second availability configuration associated with the plurality of PRACH resources. The method may include transmitting, to the network node, a message associated with the plurality of PRACH resources, wherein the plurality of PRACH resources is selected for CBRA or CFRA based on one or more of the first availability configuration or the second availability configuration.

Some aspects described herein relate to a method of wireless communication performed by a network node. The method may include transmitting, to a UE, a paging message indicating a first availability configuration associated with a plurality of PRACH resources. The method may include transmitting, to the UE, a PDCCH order indicating a second availability configuration associated with the plurality of PRACH resources. The method may include receiving, from the UE, a message associated with the plurality of PRACH resources, wherein the message is associated with CBRA or CFRA.

Some aspects described herein relate to a non-transitory computer-readable medium that stores a set of instructions for wireless communication by a UE. The set of instructions, when executed by one or more processors of the UE, may cause the UE to receive, from a network node, a paging message indicating a first availability configuration associated with a plurality of PRACH resources. The set of instructions, when executed by one or more processors of the UE, may cause the UE to receive, from the network node, a PDCCH order indicating a second availability configuration associated with the plurality of PRACH resources. The set of instructions, when executed by one or more processors of the UE, may cause the UE to transmit, to the network node, a message associated with the plurality of PRACH resources, wherein the plurality of PRACH resources is selected for CBRA or CFRA based on one or more of the first availability configuration or the second availability configuration.

Some aspects described herein relate to a non-transitory computer-readable medium that stores a set of instructions for wireless communication by a network node. The set of instructions, when executed by one or more processors of the network node, may cause the network node to transmit, to a UE, a paging message indicating a first availability configuration associated with a plurality of PRACH resources. The set of instructions, when executed by one or more processors of the network node, may cause the network node to transmit, to the UE, a PDCCH order indicating a second availability configuration associated with the plurality of PRACH resources. The set of instructions, when executed by one or more processors of the network node, may cause the network node to receive, from the UE, a message associated with the plurality of PRACH resources, wherein the message is associated with CBRA or CFRA.

Some aspects described herein relate to an apparatus for wireless communication. The apparatus may include means for receiving, from a network node, a paging message indicating a first availability configuration associated with a plurality of PRACH resources. The apparatus may include means for receiving, from the network node, a PDCCH order indicating a second availability configuration associated with the plurality of PRACH resources. The apparatus may include means for transmitting, to the network node, a message associated with the plurality of PRACH resources, wherein the plurality of PRACH resources is selected for CBRA or CFRA based on one or more of the first availability configuration or the second availability configuration.

Some aspects described herein relate to an apparatus for wireless communication. The apparatus may include means for transmitting, to a UE, a paging message indicating a first availability configuration associated with a plurality of PRACH resources. The apparatus may include means for transmitting, to the UE, a PDCCH order indicating a second availability configuration associated with the plurality of PRACH resources. The apparatus may include means for receiving, from the UE, a message associated with the plurality of PRACH resources, wherein the message is associated with CBRA or CFRA.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIG. 3 is a diagram illustrating an example of a four-step random access procedure.

FIGS. 4A and 4B are diagrams illustrating examples of a physical downlink control channel (PDCCH) order that is associated with triggering a random access channel (RACH) procedure.

FIGS. 5A-5C are diagrams illustrating examples associated with physical RACH (PRACH) resource indication via paging and PDCCH signaling.

FIG. 6 is a diagram illustrating an example process performed, for example, at a user equipment (UE) or an apparatus of a UE.

FIG. 7 is a diagram illustrating an example process performed, for example, at a network node or an apparatus of a network node.

FIGS. 8-9 are diagrams of example apparatuses for wireless communication.

### DETAILED DESCRIPTION

In a wireless network, efficient management of network resources may reduce energy consumption and increase network performance. In some examples, the network may manage physical random access channel (PRACH) resources, which are utilized for initial access procedures, such as when a user equipment (UE) connects to a network node or reestablishes a connection after losing synchronization. For example, PRACH resources may be associated with semi-static configurations in which resources are continuously available and monitored by the network, leading to increased energy consumption due to the network node continuously monitoring these resources. For example, a wireless network may dynamically adapt PRACH resources in the time domain in order to periodically indicate PRACH resource availability to UEs, thereby reducing energy usage and network overhead.

In some examples, the network node may utilize both a paging message (e.g., paging downlink control information (DCI)) and a physical downlink control channel (PDCCH) order to indicate availability of additional PRACH resources. However, where a paging message indicates that additional PRACH resources are available for a certain duration, there may be uncertainty regarding how the receiving UE addresses a subsequent PDCCH order that indicates availability of the additional PRACH resources. For example, where a PDCCH order indicates the availability of PRACH resources during the time frame already indicated by the paging message, there may be an overlap scenario in which the UE may be unable to determine whether to utilize a contention-based random access (CBRA) or a contention-free random access (CFRA) procedure.

Similarly, where the paging message indicates additional PRACH resources, such PRACH resources are unavailable for CFRA. However, where a PDCCH order is subsequently received and processed at the UE, the PDCCH order may still indicate that the additional PRACH resources are available for CFRA. As a result, the UE may be unable to reconcile the use of paging messages and PDCCH orders for availability of the additional PRACH resources.

Various aspects relate generally to the dynamic adaptation of additional PRACH resources associated with PDCCH orders and paging messages. Some aspects more specifically relate to a UE receiving, from a network node, a paging message associated with a first availability configuration, and a PDCCH order associated with a second availability configuration, and transmitting a message to the network node for either CBRA or CFRA, based on first availability configuration and the second availability configuration. In some aspects, the UE may select additional PRACH resources for CBRA or CFRA based on the timing of the first and second availability configurations and according to any overlap between the availability windows indicated by the paging message and the PDCCH order (e.g., by the first and second availability configurations, respectively). For example, the UE may select additional PRACH resources for CBRA based on an overlap between the availability windows, and the UE may select additional PRACH resources for CFRA based on a lack of overlap between the availability windows. In some aspects, the PDCCH order may indicate whether the additional PRACH resources are associated with CBRA or CFRA, and the PRACH order may further indicate whether the additional PRACH resources are associated with a dedicated resource configuration or a common resource configuration.

Particular aspects of the subject matter described in this disclosure can be implemented to realize one or more of the following technical advantages. The described techniques may enable the use of paging messages and PDCCH orders for indicating additional PRACH resource availability, which may enable the network to efficiently or dynamically manage network resources (e.g., allocation of additional PRACH resources). As a result, energy consumption and network overhead may be reduced, where the network node may limit or reduce monitoring of such resources. Similarly, by providing resource availability configurations to the UE (e.g., regarding the selection of the additional PRACH resources for CBRA or CFRA during overlapping availability windows), the network node can improve the efficiency of an associated random access procedure. As a result, the UE may access the network with improved efficiency, while the network node may avoid managing potentially unnecessary access attempts. Furthermore, by determining whether the additional PRACH resources are associated with a dedicated or common resource configuration, the UE may dynamically adapt to the PRACH resource allocation, thereby conserving processing resources, memory resources, network resources, among other examples. Additionally, where the PDCCH order indicates (e.g., via a single bit) whether the plurality of PRACH resources is associated with CBRA or CFRA, the procedure for PRACH resource selection may be simplified, thereby reducing the signaling overhead and conserving network and UE resources.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

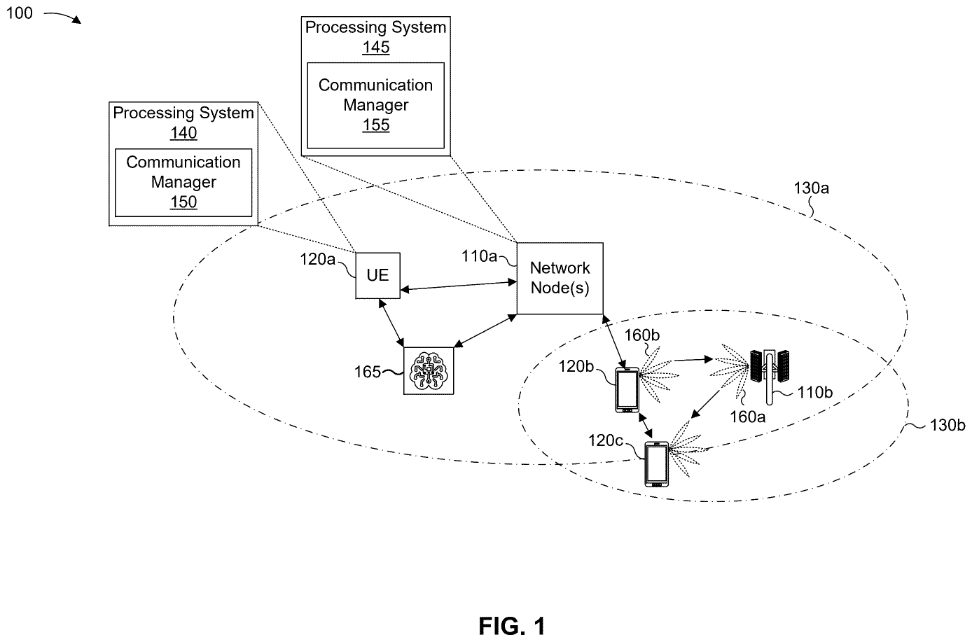

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz),

FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a DCI configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As indicated above, a BWP may be configured as a subset or a part of a total or full component carrier bandwidth and generally forms or encompasses a set of contiguous RBs within the full component carrier bandwidth. In other words, within the carrier bandwidth, a BWP starts at a specifically configured RB and may span a specific set of consecutive RBs. A UE 120 may be configured with up to four downlink BWPs and up to four uplink BWPs for each serving cell. To reduce UE power consumption, only one BWP in the downlink and one BWP in the uplink are generally active at a given time on an active serving cell under typical operation. The active BWP defines the operating bandwidth of the UE 120 within the operating bandwidth of the serving cell while all other BWPs with which the UE 120 is configured are deactivated. On deactivated BWPs, the UE 120 does not transmit or receive any communications.

A BWP may be an initial BWP (for example, an initial uplink BWP or an initial downlink BWP), a first active BWP, or a default BWP, among other examples. An initial BWP may be used by a UE 120 for initial access (for example, for a random access procedure), synchronization, or channel estimation, among other examples. A first active BWP may be a BWP that is to be active for the UE 120 after initial access is completed. A default BWP may be a BWP that the UE switches to based on, or otherwise associated with, detecting no activity on an active BWP for a given amount of time (for example, where the given amount of time is based on a configured BWP inactivity timer). In some examples, the UE 120 may switch between an active BWP and another BWP (for example, an inactive BWP or the default BWP). This may be referred to as BWP switching. In some examples, the UE 120 may switch BWPs based on, or otherwise associated with, receiving an indication to switch the active BWP (for example, where the indication is included in DCI or an RRC message from a network node 110). As another example, the UE 120 may switch BWPs based on, or otherwise associated with, detecting no activity on an active BWP for a given amount of time (for example, where the given amount of time is based on a configured BWP inactivity timer). As another example, the UE 120 may switch BWPs based on, or otherwise associated with, performing a given operation or procedure. For example, the UE 120 may switch to an initial BWP based on, or otherwise associated with, performing a random access procedure.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include PDCCHs, and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples.

In some aspects, the UE 120 may include a communication manager 150. As described in more detail elsewhere herein, the communication manager 150 may receive, from a network node 110, a paging message indicating a first availability configuration associated with a plurality of PRACH resources; receive, from the network node 110, a PDCCH order indicating a second availability configuration associated with the plurality of PRACH resources; and transmit, to the network node 110, a message associated with the plurality of PRACH resources, wherein the plurality of PRACH resources is selected for CBRA or CFRA based on one or more of the first availability configuration or the second availability configuration. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a paging message indicating a first availability configuration associated with a plurality of PRACH resources; transmit, to the UE 120, a PDCCH order indicating a second availability configuration associated with the plurality of PRACH resources; and receive, from the UE 120, a message associated with the plurality of PRACH resources, wherein the message is associated with CBRA or CFRA. Additionally, or alternatively, the communication manager 155 may perform one or more other operations described herein.

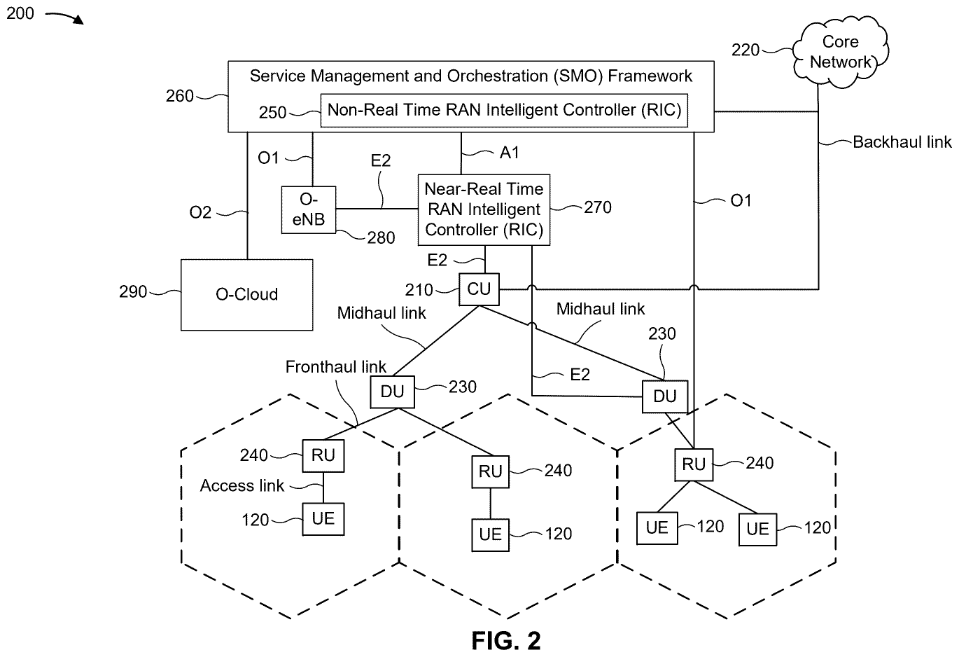

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

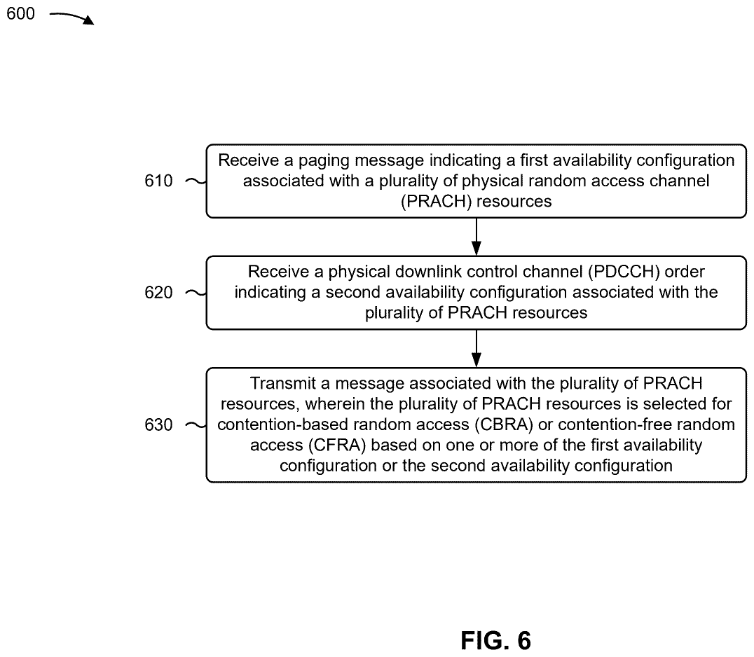

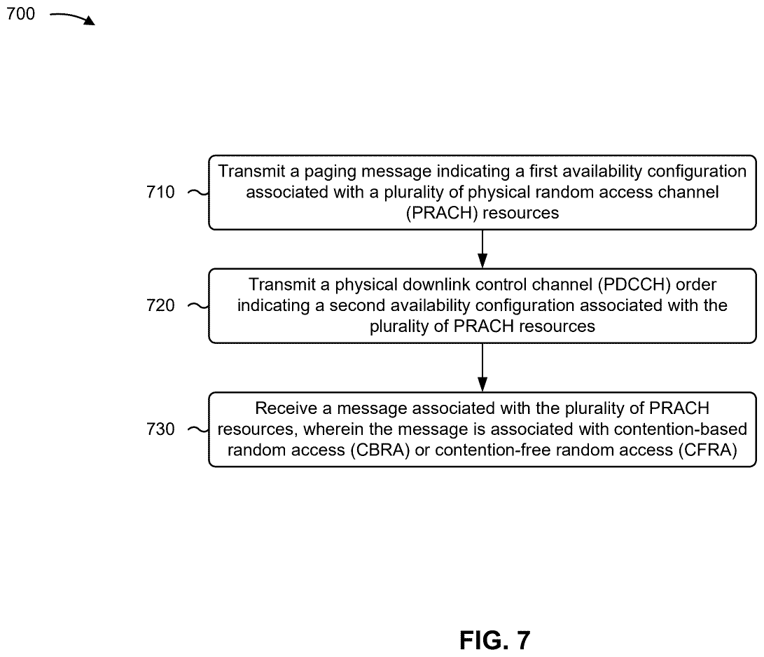

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with PRACH resource indication via paging and PDCCH signaling, as described in more detail elsewhere herein. For example, the processing system 145 of the network node 110, the processing system 140 of the UE 120, the CU 210, the DU 230, or the RU 240 may perform or direct operations of, for example, process 600 of FIG. 6, process 700 of FIG. 7, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 600 of FIG. 6, process 700 of FIG. 7, or other processes as described herein. In some examples, executing instructions may include running the instructions, converting the instructions, compiling the instructions, or interpreting the instructions, among other examples.

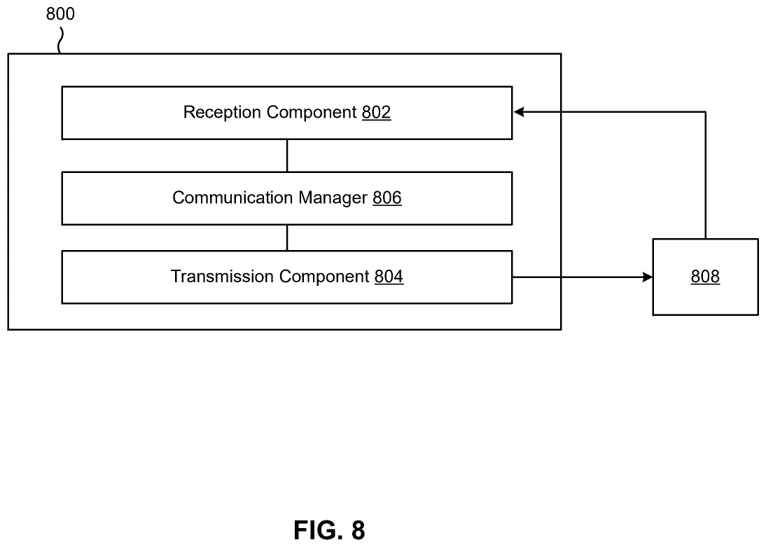

In some aspects, the UE 120 includes means for receiving, from a network node 110, a paging message indicating a first availability configuration associated with a plurality of PRACH resources; means for receiving, from the network node 110, a PDCCH order indicating a second availability configuration associated with the plurality of PRACH resources; or means for transmitting, to the network node 110, a message associated with the plurality of PRACH resources, wherein the plurality of PRACH resources is selected for CBRA or CFRA based on one or more of the first availability configuration or the second availability configuration. The means for the UE 120 to perform operations described herein may include, for example, one or more of communication manager 150, processing system 140, a radio, one or more RF chains, one or more transceivers, one or more antennas, one or more modems, a reception component (for example, reception component 802 depicted and described in connection with FIG. 8), or a transmission component (for example, transmission component 804 depicted and described in connection with FIG. 8), among other examples.

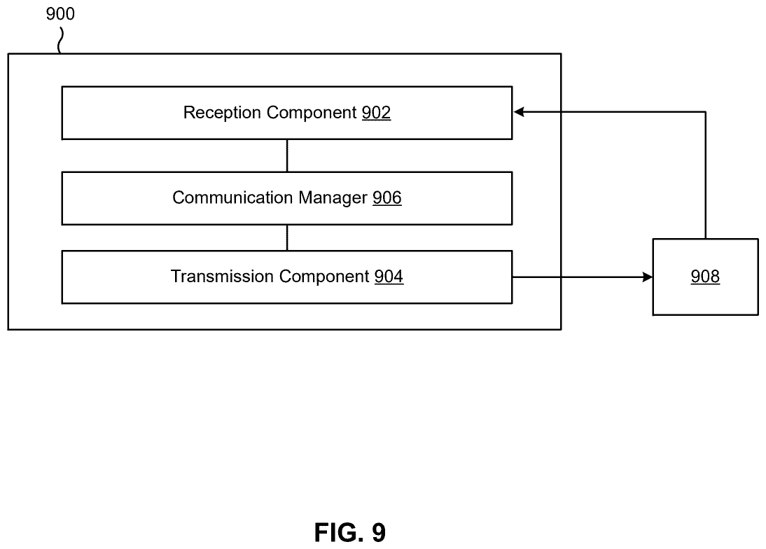

In some aspects, the network node 110 includes means for transmitting, to a UE 120, a paging message indicating a first availability configuration associated with a plurality of PRACH resources; means for transmitting, to the UE 120, a PDCCH order indicating a second availability configuration associated with the plurality of PRACH resources; or means for receiving, from the UE 120, a message associated with the plurality of PRACH resources, wherein the message is associated with CBRA or CFRA. The means for the network node to perform operations described herein may include, for example, one or more of communication manager 155, processing system 145, a radio, one or more RF chains, one or more transceivers, one or more antennas, one or more modems, a reception component (for example, reception component 902 depicted and described in connection with FIG. 9), or a transmission component (for example, transmission component 904 depicted and described in connection with FIG. 9), among other examples.

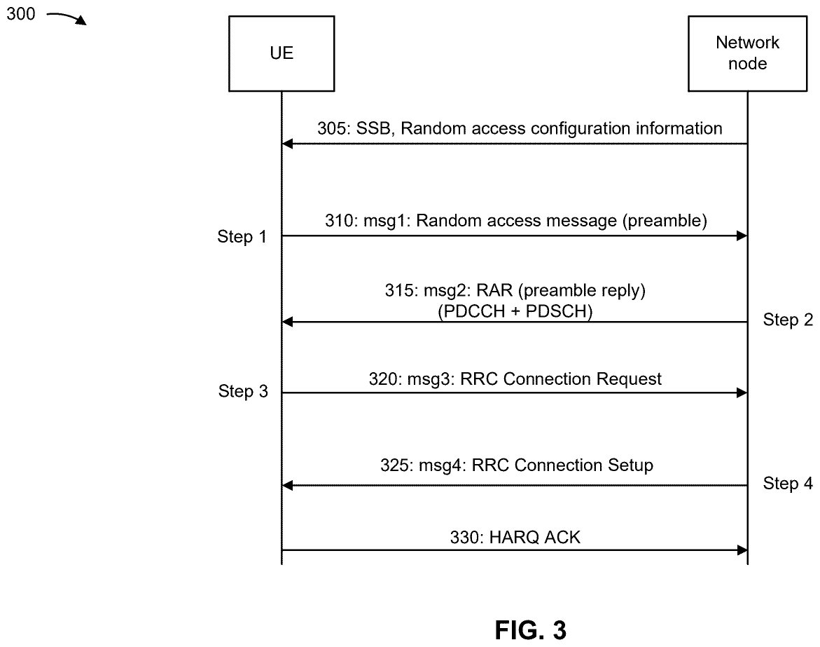

FIG. 3 is a diagram illustrating an example of a four-step random access procedure. As shown in FIG. 3, a network node (e.g., network node 110) and a UE (e.g., UE 120) may communicate with one another to perform the four-step random access procedure.

As shown by reference number 305, the network node may transmit, and the UE may receive, one or more SSBs and random access configuration information. In some aspects, the random access configuration information may be transmitted in or indicated by system information (e.g., in one or more system information blocks (SIBs)) or an SSB, such as for contention-based random access. Additionally, or alternatively, the random access configuration information may be transmitted in an RRC message or a PDCCH order message that triggers a RACH procedure, such as for contention-free random access. The random access configuration information may include one or more parameters to be used in the random access procedure, such as one or more parameters for transmitting a RAM or one or more parameters for receiving a random access response (RAR).

As shown by reference number 310, the UE may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 315, the network node may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE to transmit message 3 (msg3).

In some aspects, as part of the second step of the four-step random access procedure, the network node may transmit a PDCCH communication for the RAR. The PDCCH communication may schedule a PDSCH communication that includes the RAR. For example, the PDCCH communication may indicate a resource allocation for the PDSCH communication. Also as part of the second step of the four-step random access procedure, the network node may transmit the PDSCH communication for the RAR, as scheduled by the PDCCH communication. The RAR may be included in a MAC protocol data unit (PDU) of the PDSCH communication.

As shown by reference number 320, the UE may transmit an RRC connection request message. The RRC connection request message may be referred to as message 3, msg3, MSG3, or a third message of a four-step random access procedure. In some aspects, the RRC connection request may include a UE identifier, UCI, or a PUSCH communication (e.g., an RRC connection request).

As shown by reference number 325, the network node may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, or contention resolution information. As shown by reference number 330, if the UE successfully receives the RRC connection setup message, the UE may transmit a HARQ ACK.

In some examples, CBRA may be utilized as part of a random access procedure based on multiple UEs attempting to access the network node, and the CBRA procedure may implement a contention resolution process in order to manage potential collisions between the multiple UEs. For example, where multiple UEs select the same preamble when connecting or reconnecting to the network node, a contention resolution process is initiated to determine which UE may connect to the network node with the respective preamble. In contrast, CFRA may be utilized in scenarios where the network node assigns a specific preamble to a single UE, thereby avoiding contention between multiple UEs.

As indicated above, FIG. 3 is provided as an example. Other examples may differ from what is described with regard to FIG. 3.

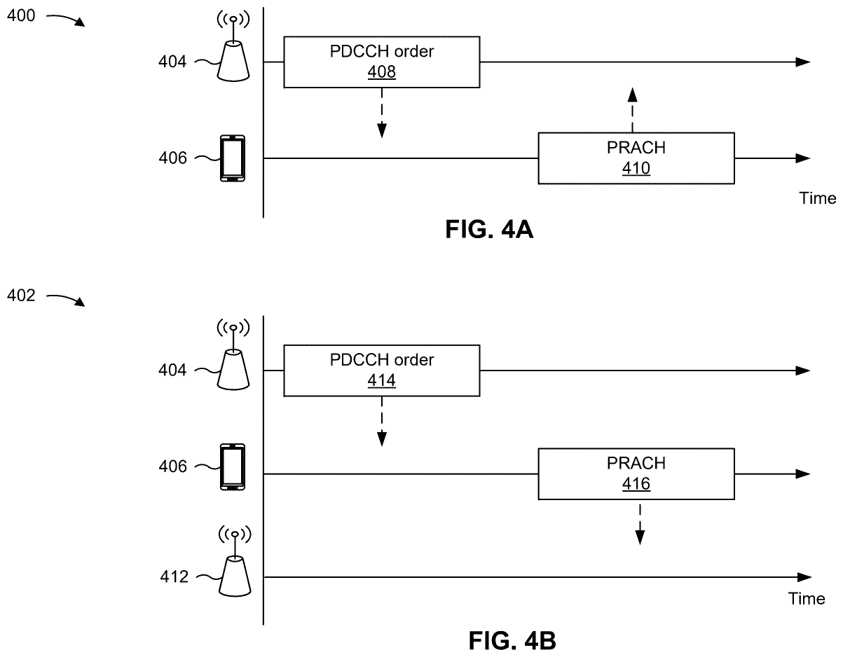

FIGS. 4A and 4B are diagrams illustrating a first example 400 and a second example 402, respectively, of a PDCCH order that is associated with triggering a RACH procedure (e.g., a PDCCH ordered RACH procedure).

In some aspects, a network node (e.g., a network node 110) may transmit a PDCCH order to instruct a UE (e.g., 120) to initiate a RACH procedure, such as the four-step RACH procedure described with regard to FIG. 3 or a two-step RACH procedure. As one example, the network node may transmit the PDCCH order in DCI based at least in part on using a DCI format that is specific to or associated with the PDCCH order. That is, the DCI format may partition the DCI into one or more fields that are specific to the PDCCH order. The network node may transmit the PDCCH order based at least in part on a variety of trigger events, such as a trigger event associated with the network node detecting that the UE's timing is out-of-sync with the network node's timing. In some aspects, the network node may transmit a PDCCH order that is associated with another network node, such as a candidate network node, as described below.

The first example 400 shown by FIG. 4A includes a communication exchange between a network node 404 (e.g., a network node 110) and a UE 406 (e.g., a UE 120). A horizontal axis in the first example 400 represents time. As described above, the network node 404 may transmit a PDCCH order 408 that instructs the UE 406 to initiate a RACH procedure. In some aspects, the network node 404 may transmit the PDCCH order in DCI based at least in part on using a DCI format specific to the PDCCH order. Additionally, or alternatively, the network node 404 may indicate random access configuration information that is associated with the RACH procedure, such as by transmitting the random access configuration information in an SIB prior to transmitting the PDCCH order 408, in an RRC message prior to transmitting the PDCCH order 408, or in the PDCCH order 408. While the random access configuration information may include one or more parameters for receiving an RAR (e.g., a configured RAR), other examples may include the random access configuration information omitting the parameter(s) associated with receiving the RAR. That is, the RAR may not be configured or may be a non-configured RAR. As shown by FIG. 4A, the UE 406 may respond to the PDCCH order 408 based at least in part on transmitting a PRACH 410 to the network node 404.

The second example 402 shown by FIG. 4B includes a communication exchange between the network node 404, the UE 406, and a second network node 412. In some aspects, the network node 404 may act as a primary cell of a master cell group or a secondary cell group (e.g., a special cell (spCell)) that provides service to the UE 406. A horizontal axis in the second example 402 represents time.

In some aspects, the network node 404 may transmit a PDCCH order 414 that instructs the UE 406 to initiate a RACH procedure (e.g., a PDCCH ordered RACH procedure) that is associated with the second network node 412. To illustrate, the second network node 412 may be a candidate network node or candidate cell for inclusion in the master cell group, inclusion in the secondary cell group, or for a UE handover (e.g., the UE 406). Accordingly, and based at least in part on acting as an spCell, the network node 404 may transmit the PDCCH order 414 to instruct the UE 406 to perform a RACH procedure with the second network node 412 or to acquire timing synchronization with the second network node 412. As shown by FIG. 4B, the UE 406 may transmit a PRACH 416 to the second network node 412 as part of performing the PDCCH ordered RACH procedure. In some aspects, a PDCCH order that is associated with a candidate network node may not be associated with a configured RAR. Based at least in part on the RAR not being configured, the UE 406 may instead obtain timing advance (TA) information associated with the second network node 412 in a cell switch command (e.g., instead of an RAR).

In some examples, the PRACH may be adapted in a time domain, based on additional PRACH resources associated with one or more UEs, including NES-capable UEs. For example, NES-capable UEs may utilize additional PRACH resources or PRACH resources that are associated with non-NES-capable UEs (e.g., PRACH resources that may be utilized by non-NES-capable UEs). In some examples, the configuration of additional PRACH resources may be provided by semi-static signaling from a network node. In some examples, for a UE in connected mode, the UE may be configured to support a 1-bit field in DCI with a cell radio network temporary identifier (C-RNTI) that may be associated with triggering PRACH (e.g., a PDCCH order that may only be monitored by connected modules) to indicate whether additional PRACH resources are available for the triggered PRACH.

In some examples, where a random access procedure is initiated by a PDCCH order, the UE may transmit (e.g., based on a request associated with one or more higher layers) a PRACH order in a selected PRACH occasion, for which a time period (e.g., in milliseconds (ms)) between the last symbol of the PDCCH order reception and the first symbol of the PRACH transmission may be greater than or equal to: N_{T,2}+Δ_{BWPSwitching}+Δ_{Delay}+T_{switch}+T_{SSB}+Δ_{RF/BB preparation}. In some examples, N_{T,2} may be associated with a time duration of N₂ symbols, which correspond to a PUSCH preparation time associated with a UE processing capability. Additionally, Δ_{BWPSwitching} may be associated with a value of 0 where an active UL BWP is unchanged or if a cell indicator field in the PDCCH order indicates a non-serving cell, or else Δ_{BWPSwitching} may be associated with a time duration for a BWP switching delay. Additionally, Δ_{Delay} may be associated with a value for one or more frequency ranges (FRs), including a first frequency range (denoted as “FR1”) or a second FR (denoted as “FR2”) (e.g., Δ_{Delay}=0.5 ms for FR1 and Δ_{Delay}=0.25 ms for FR2). Additionally, T_{switch} may be associated with a switching gap duration. Furthermore, T_{SSB} may be associated with a configured value, or T_{SSB} may be associated with a value of 0 based on a cell indicator field in the PDCCH order indicating a serving cell or based on a cell indicator field being absent in the PDCCH order. Furthermore, Δ_{RF/BB} preparation may be associated with a configured value, or Δ_{RF/BB} preparation may be associated with a value of 0 based on a cell indicator field in the PDCCH order indicating a serving cell or based on a cell indicator field being absent in the PDCCH order.

In some examples, a PDCCH order may be associated with indicating a CBRA or a CFRA process associated with one or more PRACH resources. For example, the PDCCH order may include a preamble index of zero associated with CBRA, which may indicate that a UE is to utilize one or more PRACH resources associated with a common resource configuration. Furthermore, for example, the PDCCH order may include a non-zero preamble index associated with CFRA, which may indicate that the UE is to utilize one or more PRACH resources associated with a dedicated resource configuration.

As indicated above, FIGS. 4A and 4B are provided as examples. Other examples may differ from what is described with regard to FIGS. 4A and 4B.

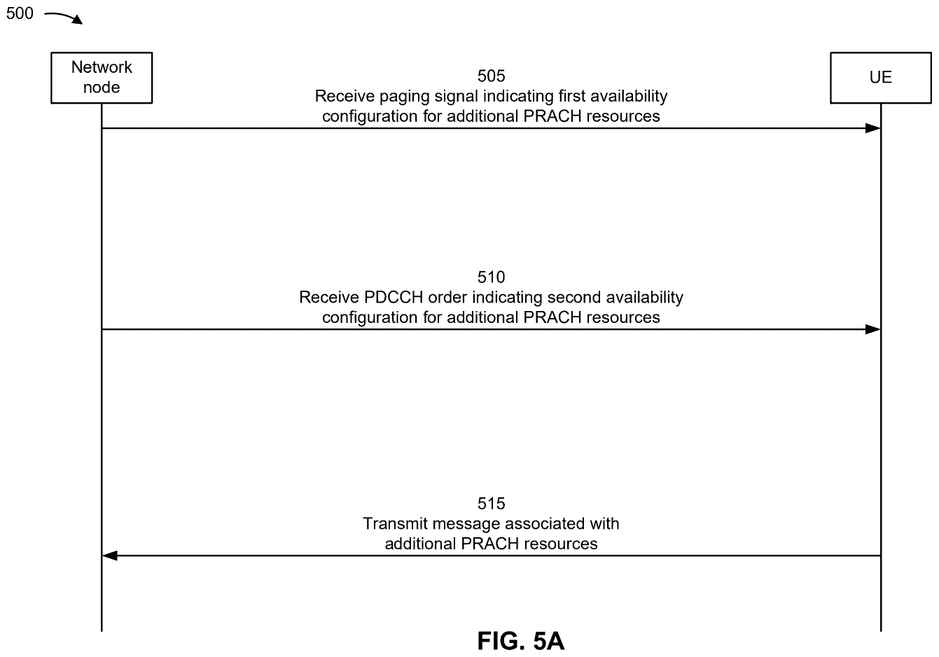

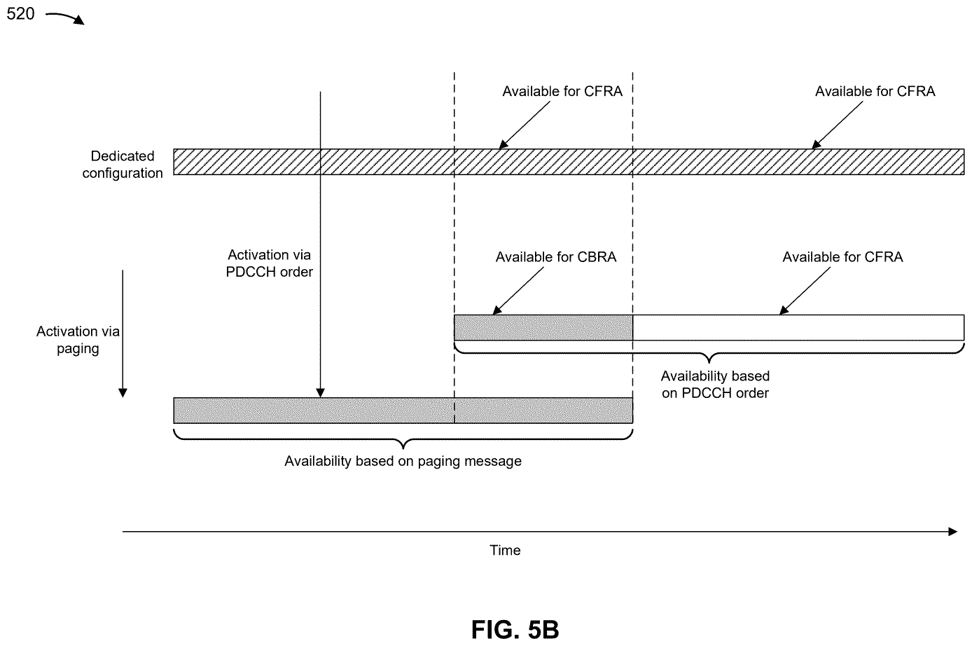

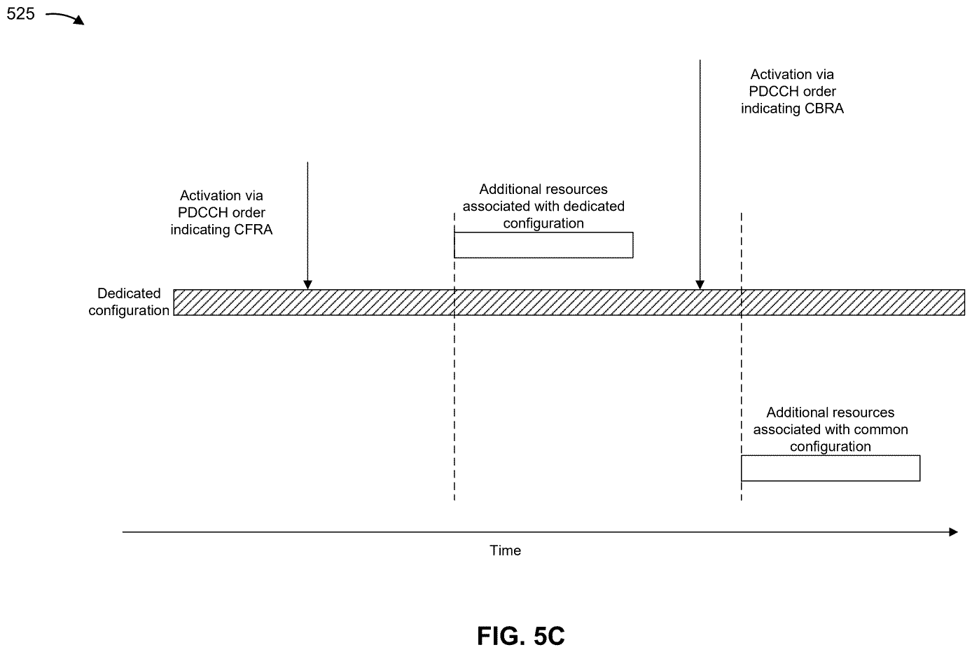

FIGS. 5A-5C are diagrams illustrating examples 500, 520, and 525 associated with PRACH resource indication via paging and PDCCH signaling. As shown in FIG. 5A, a network node (e.g., network node 110) and a UE (e.g., UE 120) may communicate with one another.

As shown by reference number 505, the network node may transmit, and the UE may receive, a paging message (e.g., paging DCI) indicating a first availability configuration associated with additional PRACH resources. For example, the paging message may be received on a specific physical channel designated for paging, such as a PDCCH, and the first availability configuration can include information such as the time intervals and frequency bands in which the PRACH resources are available. Additionally, for example, the additional PRACH resources may be indicated in addition to previously-configured PRACH resources. In some aspects, the first availability configuration is associated with a first availability window, during which the additional PRACH resources are available based on the paging message. Additionally, or alternatively, the network node may transmit, and the UE may receive, a notification of a first availability configuration associated with additional PRACH resources through a paging message. For example, the network node may notify the UE regarding the initial availability configuration for additional PRACH resources. Additionally, or alternatively, the network node may broadcast a first availability configuration for additional PRACH resources through a paging message. For example, the network node may broadcast a paging message to one or more UEs, indicating the first availability window for additional PRACH resources. Additionally, or alternatively, the paging message may identify an initial availability window (e.g., associated with the first availability configuration).

As shown by reference number 510, the network node may transmit, and the UE may receive, a PDCCH order indicating a second availability configuration associated with additional PRACH resources. For example, the additional PRACH resources may be indicated in addition to previously-configured PRACH resources. In some aspects, the second availability configuration is associated with a second availability window, during which the additional PRACH resources are available based on the PDCCH order. Additionally, or alternatively, the network node may transmit a PDCCH command that includes a secondary availability configuration for additional PRACH resources. For example, the network node may transmit, and the UE may receive, a PDCCH command that includes a secondary availability window for additional PRACH resources. Additionally, or alternatively, the network node may transmit, and the UE may receive, a PDCCH order indicating the second availability configuration for additional PRACH resources. For example, the network node may transmit, and the UE may receive, a PDCCH order that identifies a secondary availability window for the additional PRACH resources. Additionally, or alternatively, the PDCCH order may include a single bit indicating whether the additional PDCCH resources are selected for CBRA or for CFRA.

As shown by reference number 515, the UE may transmit, and the network node may receive, a message associated with the additional PRACH resources. For example, the UE may transmit a message to the network node, where the message is associated with or utilizes the additional PRACH resources. In some aspects, the message may be selected for CBRA or CFRA based on one or more of the first availability configuration or the second availability configuration. In some aspects, the message may be selected for CBRA based the UE determining that there is an overlap between the first availability window and the second availability window, and the message may be selected for CFRA based on the UE determining that there is a lack of an overlap between the first availability window and the second availability window. Additionally, or alternatively, the message may be transmitted, by the UE, in response to a message received from the network node.

Additionally, or alternatively, the transmitted message may include a random access preamble, which may be used to initiate a random access procedure. In some aspects, the UE may then monitor for an RAR message from the network node, which may include timing advance instructions and uplink resource assignments.

Additionally, or alternatively, the additional PRACH resources semi-statically configured, in which the additional PRACH resources may be configurated for and known to both the network node and the UE, but may be unavailable for continuous use. Additionally, for example, a common resource configuration or a dedicated resources configuration may always be available, allowing one or more UEs to utilize these resources at any time. However, additional PRACH resources may be configured for availability only during certain periods, as indicated by the network node, thereby enabling the network node to potentially reduce energy consumption when the additional PRACH resources are not requested or utilized. The availability of these additional PRACH resources can be indicated to the UE through paging messages or PDCCH orders, ensuring that the network node only monitors these resources periodically or according to a configuration associated with the network node.

Additionally, or alternatively, the PDCCH order may indicate an adaptation of the additional PRACH resources via one or more reserved bits, one or more PRACH mask index bits that are reserved for CFRA, or one or more SSB index bits that are reserved for CFRA, among other examples. Additionally, the adaptation of the additional PRACH resources may be associated with a least significant bit (LSB) or a most significant bit (MSB) of the PRACH mask index or of the SSB index. For example, a PDCCH order, received at the UE, may include one or more PRACH mask bits or one or more SSB index bits that indicate a configuration associated with the additional PRACH resources.

As shown in FIG. 5B, an example 520 is associated with a first availability window indicated by a paging message (e.g., paging DCI) and a second availability window indicated by a PDCCH order, with respect to additional PRACH resources available for CBRA or CFRA. In some aspects, a dedicated resource configuration may always be available for CFRA communications. For example, because the dedicated resource configuration is dedicated to a single UE, the dedicated resource configuration avoids the possibility of interference with resources that are allocated to additional UEs. Similarly, in some aspects, a common resource configuration may always be available for CBRA communications. Additionally, for example, where additional PRACH resources relative to a common resource configuration are indicated as available (e.g., via a paging message), such additional PRACH resources may be unavailable for all idle UEs. As a result, the network node may be unable to utilize such additional PRACH resources for one or more additional UEs because there is a possibility that two or more different UEs may utilize the same preamble.

In some aspects, the activation of additional PRACH resources via the paging message is depicted by the “Activation via paging” entry associated with the time axis (e.g., the x-axis). Additionally, the first availability for additional PRACH resources is depicted as the period during which these additional PRACH resources are available based on the paging message. Similarly, for example, the activation of additional PRACH resources via the PDCCH order is depicted by the “Activation via PDCCH order” entry associated with the time axis. Additionally, the second availability window for additional PRACH resources is depicted as the period during which these additional PRACH resources are available based on the PDCCH order. As a result, where the paging message and the PDCCH order activate the same additional PRACH resources (e.g., with respect to the common configuration), the two resource availability periods (e.g., activation periods associated with the paging message and the PDCCH order, respectively) may be associated with one or more overlaps (e.g., resource overlaps).

In some aspects, a segment of the availability window associated with the PDCCH order that overlaps with the segment of the availability window associated with the paging message may be utilized only for CBRA. Furthermore, a non-overlapping segment of the availability window associated with the PDCCH order (e.g., a segment of the availability window that is free from overlap with the availability window associated with the paging message) may be utilized for CFRA. In some aspects, the non-overlapping segment of the availability window associated with the PDCCH order may be unavailable for CFRA where a subsequent paging message indicates additional PRACH resources in an availability window that overlaps with the originally non-overlapping segment.

Additionally, or alternatively, one or more additional PRACH resources may be selected only for CBRA based on the availability window associated with the paging message overlapping with the availability window associated with the PDCCH order. For example, with respect to the additional PRACH resources appearing after the activation via PDCCH order, such additional PRACH resources may be selected only for CBRA based on the overlap between the availability window associated with the paging message and the availability window associated with the PDCCH order.

Additionally, or alternatively, in some aspects, one or more additional PRACH resources may be selected only for CBRA. In some aspects, the UE may obtain a configuration indicating that the one or more additional PRACH resources may be selected only for CBRA. For example, with respect to the additional PRACH resources appearing after the activation via PDCCH order, such additional PRACH resources may be selected only for CBRA, regardless of the availability indicated by the paging message.

As shown in FIG. 5C, an example 525 is associated with additional PRACH resources associated with a dedicated resource configuration and a common resource configuration. In some aspects, the dedicated resource configuration may be continuously available for CFRA communications. For example, the dedicated resource configuration may always be available for CFRA communications because the dedicated resource configuration is associated with a UE. As a result, the UE may be associated with continuous access to CFRA communications via the dedicated resource configuration.

In some aspects, a network node may transmit, and a UE may receive, an activation via a PDCCH order that indicates a CFRA process associated with additional PRACH resources. For example, the PDCCH order may include a non-zero preamble index (e.g., a preamble index associated with a value of 1), which may indicate that the additional PRACH resources are indicated for CFRA. In some aspects, the PDCCH order may indicate availability of the additional PRACH resources for the dedicated resource configuration. For example, during periods of relatively high network interference, additional dedicated resources may be dynamically assigned to UEs in order to maintain quality of service. Additionally, the PDCCH order may indicate availability of the additional PRACH resources for the dedicated resource configuration based on a paging message indicating the additional PRACH resources are associated with the common resource configuration. In some aspects, where the additional PRACH resources are associated with the dedicated resource configuration, the PDCCH order may indicate that the additional PRACH resources are associated with (e.g., selected for) the common resource configuration. For example, the additional PRACH resources may be associated with the dedicated resource configuration, and the PDCCH order may indicate that the additional PRACH resources are associated with the common resource configuration. Additionally, the PDCCH order may indicate that one or more of the additional PRACH resources are associated with one or more of the dedicated resource configuration or the common resource configuration.

Additionally, or alternatively, the network node may transmit, and the UE may receive, an activation via a PDCCH order that indicates a CBRA process associated with additional PRACH resources. For example, the PDCCH order may include a preamble index of zero, which may indicate that the additional PRACH resources are indicated for CFRA. In some aspects, where the additional PRACH resources are associated with CBRA, the PDCCH order may indicate that the additional PRACH resources are associated with the common resource configuration.

Additionally, or alternatively, the PDCCH order may dynamically manage the allocation of PRACH resources for both CBRA and CFRA, depending on the type of access required. For example, the PDCCH order may include additional fields indicating whether the additional PRACH resources may be used for CBRA or CFRA based on current network conditions or UE configurations. Additionally, or alternatively, additional PRACH resources associated with the common configuration may be utilized for CBRA. For example, these additional PRACH resources may be indicated as available via paging messages and may be utilized by multiple UEs for CBRA during the indicated availability window. For example, during a specific time window, the network node may broadcast a paging message indicating that certain additional PRACH resources are available for CBRA, thereby enabling multiple UEs to access these additional PRACH resources.

As described herein, PDCCH orders and paging messages may be utilized to dynamically adapt additional PRACH resources in a network. According to some examples described herein, a UE may receive, from a network node, a paging message associated with a first availability configuration, and a PDCCH order associated with a second availability configuration, and transmit a message to the network node for either CBRA or CFRA, based on these configurations. Additionally, the UE may select additional PRACH resources for CBRA or CFRA based on the timing of the first and second availability configurations, based on any overlap between the availability windows indicated by the paging message and the PDCCH order (e.g., by the first and second availability configurations, respectively). The UE may select PRACH resources for CBRA based on an overlap between the availability windows, and the UE may select additional PRACH resources for CFRA based on a lack of overlap between the availability windows.

As a result, the described techniques may enable the use of paging messages and PDCCH orders for indicating additional PRACH resource availability, which may enable the network to efficiently or dynamically manage network resources (e.g., allocation of additional PRACH resources) and access procedures based on current network conditions. As a result, energy consumption and network overhead may be reduced, where the network node may limit or reduce monitoring of such resources. Similarly, by providing resource availability configurations to the UE (e.g., regarding the selection of additional PRACH resources for CBRA or CFRA during overlapping availability windows), the network node can improve the efficiency of an associated random access procedure. As a result, the UE may access the network in a timely manner, while the network node may avoid managing potentially unnecessary access attempts.

As indicated above, FIGS. 5A-5C are provided as examples. Other examples may differ from what is described with respect to FIGS. 5A-5C.

FIG. 6 is a diagram illustrating an example process 600 performed, for example, at a UE or an apparatus of a UE. Example process 600 is an example where the apparatus or the UE (e.g., UE 120) performs operations associated with PRACH indication via paging and PDCCH signaling.

As shown in FIG. 6, in some aspects, process 600 may include receiving, from a network node, a paging message indicating a first availability configuration associated with a plurality of PRACH resources (block 610). For example, the UE (e.g., using reception component 802 or communication manager 806, depicted in FIG. 8) may receive, from a network node, a paging message indicating a first availability configuration associated with a plurality of PRACH resources, as described above.

As further shown in FIG. 6, in some aspects, process 600 may include receiving, from the network node, a PDCCH order indicating a second availability configuration associated with the plurality of PRACH resources (block 620). For example, the UE (e.g., using reception component 802 or communication manager 806, depicted in FIG. 8) may receive, from the network node, a PDCCH order indicating a second availability configuration associated with the plurality of PRACH resources, as described above.

As further shown in FIG. 6, in some aspects, process 600 may include transmitting, to the network node, a message associated with the plurality of PRACH resources, wherein the plurality of PRACH resources is selected for CBRA or CFRA based on one or more of the first availability configuration or the second availability configuration (block 630). For example, the UE (e.g., using transmission component 804 or communication manager 806, depicted in FIG. 8) may transmit, to the network node, a message associated with the plurality of PRACH resources, wherein the plurality of PRACH resources is selected for CBRA or CFRA based on one or more of the first availability configuration or the second availability configuration, as described above.

Process 600 may include additional aspects, such as any single aspect or any combination of aspects described below or in connection with one or more other processes described elsewhere herein.

In a first aspect, the first availability configuration is associated with a first availability window and the second availability configuration is associated with a second availability window.

In a second aspect, alone or in combination with the first aspect, the message is selected for CBRA for a segment of the second availability window based on an overlap between the segment of the second availability window and the first availability window, or the message is selected for CFRA for the segment of the second availability window based on the segment of the second availability window having no overlap with the first availability window.

In a third aspect, alone or in combination with one or more of the first and second aspects, the message is selected for CFRA based on the second availability window having no overlap with the first availability window.

In a fourth aspect, alone or in combination with one or more of the first through third aspects, the message is selected for CBRA based on the first availability window being associated with an overlap with the second availability window.

In a fifth aspect, alone or in combination with one or more of the first through fourth aspects, the message is selected for CBRA for the PRACH resources.

In a sixth aspect, alone or in combination with one or more of the first through fifth aspects, the plurality of PRACH resources is associated with a common resource configuration.

In a seventh aspect, alone or in combination with one or more of the first through sixth aspects, the plurality of PRACH resources is configured for a dedicated resource configuration and for a common resource configuration.

In an eighth aspect, alone or in combination with one or more of the first through seventh aspects, the second availability configuration indicates that the plurality of PRACH resources is selected for CFRA.

In a ninth aspect, alone or in combination with one or more of the first through eighth aspects, the second availability configuration indicates that one or more PRACH resources, of the plurality of PRACH resources, are associated with the dedicated resource configuration.

In a tenth aspect, alone or in combination with one or more of the first through ninth aspects, the first availability configuration indicates that one or more PRACH resources, of the plurality of PRACH resources, are associated with the common resource configuration.

In an eleventh aspect, alone or in combination with one or more of the first through tenth aspects, one or more PRACH resources, of the plurality of PRACH resources, are associated with the dedicated resource configuration, and the second availability configuration indicates that one or more PRACH resources, of the plurality of PRACH resources, are associated with the common resource configuration.

In a twelfth aspect, alone or in combination with one or more of the first through eleventh aspects, the second availability configuration indicates that one or more PRACH resources, of the plurality of PRACH resources, are associated with one or more of the dedicated resource configuration or the common resource configuration.

In a thirteenth aspect, alone or in combination with one or more of the first through twelfth aspects, the second availability configuration indicates that the plurality of PRACH resources is selected for CBRA and is associated with the common resource configuration.

In a fourteenth aspect, alone or in combination with one or more of the first through thirteenth aspects, the PDCCH order includes a single bit indicating whether the plurality of PRACH resources is selected for CBRA or CFRA.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram illustrating an example process 700 performed, for example, at a network node or an apparatus of a network node. Example process 700 is an example where the apparatus or the network node (e.g., network node 110) performs operations associated with PRACH resource indication via paging and PDCCH signaling.

As shown in FIG. 7, in some aspects, process 700 may include transmitting, to a UE, a paging message indicating a first availability configuration associated with a plurality of PRACH resources (block 710). For example, the network node (e.g., using transmission component 904 or communication manager 906, depicted in FIG. 9) may transmit, to a UE, a paging message indicating a first availability configuration associated with a plurality of PRACH resources, as described above.

As further shown in FIG. 7, in some aspects, process 700 may include transmitting, to the UE, a PDCCH order indicating a second availability configuration associated with the plurality of PRACH resources (block 720). For example, the network node (e.g., using transmission component 904 or communication manager 906, depicted in FIG. 9) may transmit, to the UE, a PDCCH order indicating a second availability configuration associated with the plurality of PRACH resources, as described above.

As further shown in FIG. 7, in some aspects, process 700 may include receiving, from the UE, a message associated with the plurality of PRACH resources, wherein the message is associated with CBRA or CFRA (block 730). For example, the network node (e.g., using reception component 902 or communication manager 906, depicted in FIG. 9) may receive, from the UE, a message associated with the plurality of PRACH resources, wherein the message is associated with CBRA or CFRA, as described above.

Process 700 may include additional aspects, such as any single aspect or any combination of aspects described below or in connection with one or more other processes described elsewhere herein.

In a first aspect, the first availability configuration is associated with a first availability window and the second availability configuration is associated with a second availability window.

In a second aspect, alone or in combination with the first aspect, the message is associated with CBRA for a segment of the second availability window based on an overlap between the segment of the second availability window and the first availability window, or the message is associated with CFRA for the segment of the second availability window based on the segment of the second availability window having no overlap with the first availability window.

In a third aspect, alone or in combination with one or more of the first and second aspects, the message is associated with CFRA based on the second availability window having no overlap with the first availability window.

In a fourth aspect, alone or in combination with one or more of the first through third aspects, the message is associated with CBRA based on the first availability window being associated with an overlap with the second availability window.

In a fifth aspect, alone or in combination with one or more of the first through fourth aspects, the message is associated with CBRA for the PRACH resources.

In a sixth aspect, alone or in combination with one or more of the first through fifth aspects, the plurality of PRACH resources is associated with a common resource configuration.

In a seventh aspect, alone or in combination with one or more of the first through sixth aspects, the plurality of PRACH resources is configured for a dedicated resource configuration and for a common resource configuration.

In an eighth aspect, alone or in combination with one or more of the first through seventh aspects, the second availability configuration indicates that the plurality of PRACH resources is associated with CFRA.

In a ninth aspect, alone or in combination with one or more of the first through eighth aspects, the second availability configuration indicates that one or more PRACH resources, of the plurality of PRACH resources, are associated with the dedicated resource configuration.

In a tenth aspect, alone or in combination with one or more of the first through ninth aspects, the second availability configuration indicates that the one or more PRACH resources, of the plurality of PRACH resources, are associated with the dedicated resource configuration, based on a determination that the first availability configuration indicates that one or more PRACH resources, of the plurality of PRACH resources, are associated with the common resource configuration.

In an eleventh aspect, alone or in combination with one or more of the first through tenth aspects, the second availability configuration indicates that one or more PRACH resources, of the plurality of PRACH resources, are associated with the common resource configuration, based on a determination that one or more PRACH resources, of the plurality of PRACH resources, are associated with the dedicated resource configuration.

In a twelfth aspect, alone or in combination with one or more of the first through eleventh aspects, the second availability configuration indicates that one or more PRACH resources, of the plurality of PRACH resources, are associated with one or more of the dedicated resource configuration or the common resource configuration.

In a thirteenth aspect, alone or in combination with one or more of the first through twelfth aspects, the second availability configuration indicates that the plurality of PRACH resources is selected for CBRA and is associated with the common resource configuration.

In a fourteenth aspect, alone or in combination with one or more of the first through thirteenth aspects, the PDCCH order includes a single bit indicating whether the plurality of PRACH resources is associated with CBRA or CFRA.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram of an example apparatus 800 for wireless communication. The apparatus 800 may be a UE, or a UE may include the apparatus 800. In some aspects, the apparatus 800 includes a reception component 802, a transmission component 804, or a communication manager 806, which may be in communication with one another (for example, via one or more buses or one or more other components). In some aspects, the communication manager 806 is the communication manager 150 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 140 described in connection with FIG. 1) of the UE.

In some aspects, the apparatus 800 may be configured to perform one or more operations described herein in connection with FIGS. 5A, 5B, or 5C. Additionally, or alternatively, the apparatus 800 may be configured to perform one or more processes described herein, such as process 600 of FIG. 6. In some aspects, the apparatus 800 or one or more components shown in FIG. 8 may include one or more components of the UE described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the UE described above in connection with FIG. 1, such as a radio, one or more RF chains, one or more transceivers, or one or more modems, each of which may in turn be coupled with one or more antennas of the UE.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 804 may be co-located with the reception component 802.

The communication manager 806 may support operations of the reception component 802 or the transmission component 804. For example, the communication manager 806 may receive information associated with configuring reception of communications by the reception component 802 or transmission of communications by the transmission component 804. Additionally, or alternatively, the communication manager 806 may generate or provide control information to the reception component 802 or the transmission component 804 to control reception or transmission of communications.

The reception component 802 may receive, from a network node, a paging message indicating a first availability configuration associated with a plurality of PRACH resources. The reception component 802 may receive, from the network node, a PDCCH order indicating a second availability configuration associated with the plurality of PRACH resources. The transmission component 804 may transmit, to the network node, a message associated with the plurality of PRACH resources, wherein the plurality of PRACH resources is selected for CBRA or CFRA based on one or more of the first availability configuration or the second availability configuration.

The number and arrangement of components shown in FIG. 8 are provided as an example. In practice, there may be additional components, fewer components, different components, or differently arranged components than those shown in FIG. 8.

Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

FIG. 9 is a diagram of an example apparatus 900 for wireless communication. The apparatus 900 may be a network node, or a network node may include the apparatus 900. In some aspects, the apparatus 900 includes a reception component 902, a transmission component 904, or a communication manager 906, which may be in communication with one another (for example, via one or more buses or one or more other components). In some aspects, the communication manager 906 is the communication manager 155 described in connection with FIG. 1. As shown, the apparatus 900 may communicate with another apparatus 908, such as a UE or a network node (such as a CU, a DU, an RU, or a base station), using the reception component 902 and the transmission component 904. The communication manager 906 may be included in, or implemented via, a processing system (for example, the processing system 145 described in connection with FIG. 1) of the network node.

In some aspects, the apparatus 900 may be configured to perform one or more operations described herein in connection with FIGS. 5A, 5B, or 5C. Additionally, or alternatively, the apparatus 900 may be configured to perform one or more processes described herein, such as process 700 of FIG. 7. In some aspects, the apparatus 900 or one or more components shown in FIG. 9 may include one or more components of the network node described in connection with FIG. 1. Additionally, or alternatively, one or more components shown in FIG. 9 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications, and may provide the processed signals to the one or more other components of the apparatus 900. In some aspects, the reception component 902 may include one or more components of the network node described above in connection with FIG. 1, such as a radio, one or more RF chains, one or more transceivers, or one or more modems, each of which may in turn be coupled with one or more antennas of the network node. In some aspects, the reception component 902 or the transmission component 904 may include or may be included in a network interface. The network interface may be configured to obtain or output signals for the apparatus 900 via one or more communications links, such as a backhaul link, a midhaul link, or a fronthaul link.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications, and may transmit the processed signals to the apparatus 908. In some aspects, the transmission component 904 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 904 may be co-located with the reception component 902.

The communication manager 906 may support operations of the reception component 902 or the transmission component 904. For example, the communication manager 906 may receive information associated with configuring reception of communications by the reception component 902 or transmission of communications by the transmission component 904. Additionally, or alternatively, the communication manager 906 may generate or provide control information to the reception component 902 or the transmission component 904 to control reception or transmission of communications.

The transmission component 904 may transmit, to a UE, a paging message indicating a first availability configuration associated with a plurality of PRACH resources. The transmission component 904 may transmit, to the UE, a PDCCH order indicating a second availability configuration associated with the plurality of PRACH resources. The reception component 902 may receive, from the UE, a message associated with the plurality of PRACH resources, wherein the message is associated with CBRA or CFRA.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:
Aspect 1: A method of wireless communication performed by a user equipment (UE), comprising: receiving, from a network node, a paging message indicating a first availability configuration associated with a plurality of physical random access channel (PRACH) resources; receiving, from the network node, a physical downlink control channel (PDCCH) order indicating a second availability configuration associated with the plurality of PRACH resources; and transmitting, to the network node, a message associated with the plurality of PRACH resources, wherein the plurality of PRACH resources is selected for contention-based random access (CBRA) or contention-free random access (CFRA) based on one or more of the first availability configuration or the second availability configuration.
Aspect 2: The method of Aspect 1, wherein the first availability configuration is associated with a first availability window and the second availability configuration is associated with a second availability window.
Aspect 3: The method of Aspect 2, wherein the message is selected for CBRA for a segment of the second availability window based on an overlap between the segment of the second availability window and the first availability window, or wherein the message is selected for CFRA for the segment of the second availability window based on the segment of the second availability window having no overlap with the first availability window.
Aspect 4: The method of Aspect 2, wherein the message is selected for CFRA based on the second availability window having no overlap with the first availability window.
Aspect 5: The method of Aspect 2, wherein the message is selected for CBRA based on the first availability window being associated with an overlap with the second availability window.
Aspect 6: The method of Aspect 2, wherein the message is selected for CBRA for the PRACH resources.
Aspect 7: The method of Aspect 2, wherein the plurality of PRACH resources is associated with a common resource configuration.
Aspect 8: The method of any of Aspects 1-7, wherein the plurality of PRACH resources is configured for a dedicated resource configuration and for a common resource configuration.
Aspect 9: The method of Aspect 8, wherein the second availability configuration indicates that the plurality of PRACH resources is selected for CFRA.
Aspect 10: The method of Aspect 9, wherein the second availability configuration indicates that one or more PRACH resources, of the plurality of PRACH resources, are associated with the dedicated resource configuration.
Aspect 11: The method of Aspect 10, wherein the first availability configuration indicates that one or more PRACH resources, of the plurality of PRACH resources, are associated with the common resource configuration.
Aspect 12: The method of Aspect 8, wherein one or more PRACH resources, of the plurality of PRACH resources, are associated with the dedicated resource configuration, and the second availability configuration indicates that one or more PRACH resources, of the plurality of PRACH resources, are associated with the common resource configuration.
Aspect 13: The method of Aspect 8, wherein the second availability configuration indicates that one or more PRACH resources, of the plurality of PRACH resources, are associated with one or more of the dedicated resource configuration or the common resource configuration.
Aspect 14: The method of Aspect 8, wherein the second availability configuration indicates that the plurality of PRACH resources is selected for CBRA and is associated with the common resource configuration.
Aspect 15: The method of Aspect 8, wherein the PDCCH order includes a single bit indicating whether the plurality of PRACH resources is selected for CBRA or CFRA.
Aspect 16: A method of wireless communication performed by a network node, comprising: transmitting, to a user equipment (UE), a paging message indicating a first availability configuration associated with a plurality of physical random access channel (PRACH) resources; transmitting, to the UE, a physical downlink control channel (PDCCH) order indicating a second availability configuration associated with the plurality of PRACH resources; and receiving, from the UE, a message associated with the plurality of PRACH resources, wherein the message is associated with contention-based random access (CBRA) or contention-free random access (CFRA).
Aspect 17: The method of Aspect 16, wherein the first availability configuration is associated with a first availability window and the second availability configuration is associated with a second availability window.
Aspect 18: The method of Aspect 17, wherein the message is associated with CBRA for a segment of the second availability window based on an overlap between the segment of the second availability window and the first availability window, or wherein the message is associated with CFRA for the segment of the second availability window based on the segment of the second availability window having no overlap with the first availability window.
Aspect 19: The method of Aspect 17, wherein the message is associated with CFRA based on the second availability window having no overlap with the first availability window.
Aspect 20: The method of Aspect 17, wherein the message is associated with CBRA based on the first availability window being associated with an overlap with the second availability window.
Aspect 21: The method of Aspect 17, wherein the message is associated with CBRA for the PRACH resources.
Aspect 22: The method of Aspect 17, wherein the plurality of PRACH resources is associated with a common resource configuration.
Aspect 23: The method of any of Aspects 16-22, wherein the plurality of PRACH resources is configured for a dedicated resource configuration and for a common resource configuration.
Aspect 24: The method of Aspect 23, wherein the second availability configuration indicates that the plurality of PRACH resources is associated with CFRA.
Aspect 25: The method of Aspect 24, wherein the second availability configuration indicates that one or more PRACH resources, of the plurality of PRACH resources, are associated with the dedicated resource configuration.
Aspect 26: The method of Aspect 25, wherein the second availability configuration indicates that the one or more PRACH resources, of the plurality of PRACH resources, are associated with the dedicated resource configuration, based on a determination that the first availability configuration indicates that one or more PRACH resources, of the plurality of PRACH resources, are associated with the common resource configuration.
Aspect 27: The method of Aspect 23, wherein the second availability configuration indicates that one or more PRACH resources, of the plurality of PRACH resources, are associated with the common resource configuration, based on a determination that one or more PRACH resources, of the plurality of PRACH resources, are associated with the dedicated resource configuration.
Aspect 28: The method of Aspect 23, wherein the second availability configuration indicates that one or more PRACH resources, of the plurality of PRACH resources, are associated with one or more of the dedicated resource configuration or the common resource configuration.
Aspect 29: The method of Aspect 23, wherein the second availability configuration indicates that the plurality of PRACH resources is selected for CBRA and is associated with the common resource configuration.
Aspect 30: The method of Aspect 23, wherein the PDCCH order includes a single bit indicating whether the plurality of PRACH resources is associated with CBRA or CFRA.
Aspect 31: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-30.
Aspect 32: An apparatus for wireless communication at a device, the apparatus comprising one or more memories and one or more processors coupled to the one or more memories, the one or more processors configured to cause the device to perform the method of one or more of Aspects 1-30.
Aspect 33: An apparatus for wireless communication, the apparatus comprising at least one means for performing the method of one or more of Aspects 1-30.
Aspect 34: A non-transitory computer-readable medium storing code for wireless communication, the code comprising instructions executable by one or more processors to perform the method of one or more of Aspects 1-30.
Aspect 35: A non-transitory computer-readable medium storing a set of instructions for wireless communication, the set of instructions comprising one or more instructions that, when executed by one or more processors of a device, cause the device to perform the method of one or more of Aspects 1-30.
Aspect 36: A device for wireless communication, the device comprising a processing system that includes one or more processors and one or more memories coupled with the one or more processors, the processing system configured to cause the device to perform the method of one or more of Aspects 1-30.
Aspect 37: An apparatus for wireless communication at a device, the apparatus comprising one or more memories and one or more processors coupled to the one or more memories, the one or more processors individually or collectively configured to cause the device to perform the method of one or more of Aspects 1-30.
Aspect 38: A device comprising a processing system that includes one or more processors and one or more code-storing memories coupled with the one or more processors, the processing system configured to cause the device to perform the method of one or more of Aspects 1-30.
Aspect 39: A device comprising a processing system that includes processor circuitry and code-storing memory circuitry, the processing system configured to cause the device to perform the method of one or more of Aspects 1-30.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a network node, a paging message indicating a first availability configuration associated with a plurality of physical random access channel (PRACH) resources;
receive, from the network node, a physical downlink control channel (PDCCH) order indicating a second availability configuration associated with the plurality of PRACH resources; and
transmit, to the network node, a message associated with the plurality of PRACH resources, wherein the plurality of PRACH resources is selected for contention-based random access (CBRA) or contention-free random access (CFRA) based on one or more of the first availability configuration or the second availability configuration.

2. The UE of claim 1, wherein the first availability configuration is associated with a first availability window and the second availability configuration is associated with a second availability window.

3. The UE of claim 2, wherein the message is selected for CBRA for a segment of the second availability window based on an overlap between the segment of the second availability window and the first availability window, or wherein the message is selected for CFRA for the segment of the second availability window based on the segment of the second availability window having no overlap with the first availability window.

4. The UE of claim 2, wherein the message is selected for CFRA based on the second availability window having no overlap with the first availability window.

5. The UE of claim 2, wherein the message is selected for CBRA based on the first availability window being associated with an overlap with the second availability window.

6. The UE of claim 2, wherein the message is selected for CBRA for the PRACH resources.

7. The UE of claim 2, wherein the plurality of PRACH resources is associated with a common resource configuration.

8. The UE of claim 1, wherein the plurality of PRACH resources is configured for a dedicated resource configuration and for a common resource configuration.

9. The UE of claim 8, wherein the second availability configuration indicates that the plurality of PRACH resources is selected for CFRA.

10. The UE of claim 9, wherein the second availability configuration indicates that one or more PRACH resources, of the plurality of PRACH resources, are associated with the dedicated resource configuration.

11. The UE of claim 10, wherein the first availability configuration indicates that one or more PRACH resources, of the plurality of PRACH resources, are associated with the common resource configuration.

12. The UE of claim 8, wherein one or more PRACH resources, of the plurality of PRACH resources, are associated with the dedicated resource configuration, and the second availability configuration indicates that one or more PRACH resources, of the plurality of PRACH resources, are associated with the common resource configuration.

13. The UE of claim 8, wherein the second availability configuration indicates that one or more PRACH resources, of the plurality of PRACH resources, are associated with one or more of the dedicated resource configuration or the common resource configuration.

14. The UE of claim 8, wherein the second availability configuration indicates that the plurality of PRACH resources is selected for CBRA and is associated with the common resource configuration.

15. The UE of claim 8, wherein the PDCCH order includes a single bit indicating whether the plurality of PRACH resources is selected for CBRA or CFRA.

16. A network node, comprising:
a processing system that includes one or more processors and one or more code-storing memories coupled with the one or more processors, the processing system configured to cause the network node to:
transmit, to a user equipment (UE), a paging message indicating a first availability configuration associated with a plurality of physical random access channel (PRACH) resources;
transmit, to the UE, a physical downlink control channel (PDCCH) order indicating a second availability configuration associated with the plurality of PRACH resources; and
receive, from the UE, a message associated with the plurality of PRACH resources, wherein the message is associated with contention-based random access (CBRA) or contention-free random access (CFRA).

17. The network node of claim 16, wherein the plurality of PRACH resources is configured for a dedicated resource configuration and for a common resource configuration.

18. The network node of claim 17, wherein the second availability configuration indicates that the plurality of PRACH resources is associated with CFRA, wherein the second availability configuration indicates that one or more PRACH resources, of the plurality of PRACH resources, are associated with the dedicated resource configuration, and wherein the second availability configuration indicates that the one or more PRACH resources, of the plurality of PRACH resources, are associated with the dedicated resource configuration, based on a determination that the first availability configuration indicates that one or more PRACH resources, of the plurality of PRACH resources, are associated with the common resource configuration.

19. The network node of claim 17, wherein the second availability configuration indicates that one or more PRACH resources, of the plurality of PRACH resources, are associated with the common resource configuration, based on a determination that one or more PRACH resources, of the plurality of PRACH resources, are associated with the dedicated resource configuration.

20. A method of wireless communication performed by a user equipment (UE), comprising:
receiving, from a network node, a paging message indicating a first availability configuration associated with a plurality of physical random access channel (PRACH) resources;
receiving, from the network node, a physical downlink control channel (PDCCH) order indicating a second availability configuration associated with the plurality of PRACH resources; and
transmitting, to the network node, a message associated with the plurality of PRACH resources, wherein the plurality of PRACH resources is selected for contention-based random access (CBRA) or contention-free random access (CFRA) based on one or more of the first availability configuration or the second availability configuration.
